(19) United States
(12) Patent Application Publication
(10) Pub. No.: US 2004/0142235 A1
(43) Pub. Date: Jul. 22, 2004

(54) Lithium polymer battery design

(76) Inventor: Mohammad Parsian, Swartz Creek, MI (US)

Correspondence Address: MARGARET A. DOBROWITSKY, DELPHI TECHNOLOGIES, INC., Legal Staff, Mail Code: 480-410-202, P.O. Box 5052, Troy, MI, 48007-5052, US

(21) Appl. No.: 10/348,749

(22) Filed: Jan. 22, 2003

(51) Int. Cl. H01M 10/04; H01M 4/02; H01M 4/64

(52) U.S. Cl. 429/128; 429/130; 429/241; 29/623.4

(57) ABSTRACT

A lithium polymer battery configured with at least one continuous electrode and at least two discontinuous electrodes having an opposite charge from the continuous electrode. The continuous electrode may be either an anode or a cathode, and the discontinuous electrode is the other of the continuous electrode. The cell may be a multicell or a multibicell. The continuous electrode is the outermost electrode of a configured cell, and facilitates such configurations such as folding the cell, rolling the cell, etc. The discontinuous electrode is in the interior of the configured cell. The adhered layers of the cell thus configured have enhanced processing and performance efficiency, and may be manufactured with greater productivity and decreased costs.

### TECHNICAL FIELD

This invention relates to a method of preparation of lithium cells, in particular lithium ion and lithium ion polymer batteries.

### BACKGROUND OF THE INVENTION

Lithium ion cells and batteries are secondary (i.e., rechargeable) energy storage devices well known in the art. The lithium ion cell, known also as a rocking chair type lithium ion battery, typically comprises essentially a carbonaceous anode (negative electrode) that is capable of intercalating lithium ions, a lithium-retentive cathode (positive electrode) that is also capable of intercalating lithium ions, and a non-aqueous, lithium ion conducting electrolyte therebetween.

The carbon anode comprises any of the various types of carbon (e.g., graphite, coke, carbon fiber, etc.) which are capable of reversibly storing lithium species, and which are bonded to an electrochemically conductive current collector (e.g. copper foil, grid, or mesh) by means of a suitable organic binder (e.g., polyvinylidene fluoride, PVdF).

The cathode comprises such materials as transition metal chalcogenides that are bonded to an electrochemically conductive current collector (e.g., aluminum foil, grid, or mesh) by a suitable organic binder. Chalcogenide compounds include oxides, sulfides, selenides, and tellurides of such metals as vanadium, titanium, chromium, copper, molybdenum, niobium, iron, nickel, cobalt and manganese. Lithiated transition metal oxides are at present the preferred positive electrode intercalation compounds. Examples of suitable cathode materials include LiMnO₂, LiCoO₂, LiNiO₂, and LiFePO4, their solid solutions and/or their combination with other metal oxides and dopant elements, e.g., titanium, magnesium, aluminum, boron, etc.

The electrolyte in such lithium ion cells comprises a lithium salt dissolved in a non-aqueous solvent which may be (1) completely liquid, (2) an immobilized liquid (e.g., gelled or entrapped in a polymer matrix), or (3) a pure polymer. Known polymer matrices for entrapping the electrolyte include polyacrylates, polyurethanes, polydialkylsiloxanes, polymethacrylates, polyphosphazenes, polyethers, polyvinylidene fluoride, polyolefins such as polypropylene and polyethylene, and polycarbonates, and may be polymerized in situ in the presence of the electrolyte to trap the electrolyte therein as the polymerization occurs. Known polymers for pure polymer electrolyte systems include polyethylene oxide (PEO), polymethylene-polyethylene oxide (MPEO), or polyphosphazenes (PPE). Known lithium salts for this purpose include, for example, LiPF₆, LiClO₄, LiSCN, LiAlCl₄, LiBF₄, LiN(CF₃SO₂)₂, LiCF₃SO₃, LiC(SO₂CF₃)₃, LiO₃SCF₂CF₃, LiC₆F₅SO₃, LiO₂CF₃, LiAsF₆, and LiSbF₆. Known organic solvents for the lithium salts include, for example, alkylcarbonates (e.g., propylene carbonate, ethylene carbonate), dialkyl carbonates, cyclic ethers, cyclic esters, glymes, lactones, formates, esters, sulfones, nitrites, and oxazolidinones. The electrolyte is incorporated into pores in a separator layer between the cathode and anode. The separator may be glass mat, for example, containing a small percentage of a polymeric material, or may be any other suitable ceramic or ceramic/polymer material. Silica is a typical main component of the separator layer.

During processing of the cell precursor, a large quantity of a homogeneously distributed plasticizer is present in the solid polymeric matrix in order to create porosity. For example, the plasticizer may be propylene carbonate, phthalic acid diesters, adipic acid diesters, acetic acid esters, organic phosphates, and/or trimellitic acid triesters. These plasticizers must be removed before the cell is activated with an electrolyte because, if mixed with the electrolyte, the plasticizers can damage the cell. The plasticizers are generally removed by extracting them into a solvent, such as diethyl ether or hexane, which selectively extract the plasticizer without significantly affecting the polymer matrix. This produces a “dry” electrolytic cell precursor, in that the precursor does not contain any electrolyte solvent or salt. An electrolyte solvent and electrolyte salt solution is then imbibed into the “dry” electrolytic cell copolymer membrane structure to yield a functional electrolytic cell system. The ion-conducting electrolyte provides ion transfer from one electrode to the other, and commonly permeates the porous structure of each of the electrodes and the separator.

Lithium and lithium ion polymer cells are often made by adhering, e.g., by laminating, thin films of the anode, cathode and/or electrolyte/separator together. Each of these components is individually prepared, for example, by coating, extruding, or otherwise, from compositions including one or more binder materials and a plasticizer. The electrolyte/separator is adhered to an electrode (anode or cathode) to form a subassembly, or is adheringly sandwiched between the anode and cathode layers to form an individual cell or unicell. A second electrolyte/separator and a second corresponding electrode may be adhered to form a bicell of, sequentially, a first counter electrode, a film separator, a central electrode, a film separator, and a second counter electrode. A number of cells are adhered and bundled together to form a high energy/voltage battery or multicell.

In constructing a lithium-ion cell, an anodic current collector may be positioned adjacent a single anode film, or sandwiched between two separate anode films, to form the negative electrode. Similarly, a cathodic current collector may be positioned adjacent a single cathode film, or sandwiched between two separate cathode films, to form the positive electrode. A separator is positioned between the negative electrode and the positive electrode. The anode, separator, and cathode structures are then adhered together (e.g., by laminating) to produce a unitary flexible electrolytic cell precursor.

Depending upon the cell, physical manipulations may be problematic. For example, a cell having a plurality of layers may be bulky, may not bundle tightly, and/or may not bundle uniformly. As a result, the cell may not have the desired physical and performance properties. There is thus a need for methods to enhance processing and performance efficiency that will provide advantages, such as improved productivity and decreased costs.

### SUMMARY OF THE INVENTION

The present invention provides a lithium polymer battery comprising at least one cell, said cell comprising a first electrode, a second electrode of opposite charge from the first electrode, and a separator between the first and second electrodes, the first electrode configured continuously and the second electrode configured discontinuously. The cell may be configured as a multicell or a multibicell. The battery may contain a current collector for at least one of the electrodes, either on an outer or inner surface of an electrode, or between layers or films of electrodes having the same charge.

The present invention also provides a lithium polymer battery comprising at least one cell with a first electrode, a second electrode of opposite charge from the first electrode, and a separator between the first and second electrodes, the battery in a corrugated configuration. In the corrugated configuration the first electrode is in the interior of a folded cell and is configured discontinuously, and the second electrode is the exterior electrode of a folded cell and is configured continuously. The battery may also comprise a current collector for at least one of the electrodes. The current collector may be on an outer surface of the exterior electrode and configured continuously, or it may be on an outer surface of the inner electrode and configured discontinuously, or it may be between layers or films of electrodes having the same charge.

The present invention also provides a method for preparing a lithium polymer cell. The method comprises (a) providing a first electrode configured continuously, second electrodes configured discontinuously, and a separator between the first and second electrodes, and (b) adhering the separator to the first and second electrodes to form a cell, such as a multicell or a multibicell. The method may further include folding the cell at the junctures of the discontinuous electrodes with the discontinuous electrodes on the interior of the cell. The method may also comprise repeating steps (a) and (b) to form a plurality of cells and adhering the plurality of cells to form a battery, and folding the battery at the junctures of the discontinuous electrodes with the discontinuous electrodes on the interior of the battery. The cells may be adhered in a single process, and the process may be controlled by a thermal management system.

There is thus provided a lithium cell that provides enhanced processing and performance efficiency, and a method of manufacturing the cell with greater productivity and decreased costs.

### BRIEF DESCRIPTION OF THE DRAWINGS

The present invention will now be described, by way of example, with reference to the accompanying drawings, in which:

FIG. 1 is a diagrammatic illustration of a front view of one embodiment of a cell having one anode and multiple cathodes.

FIG. 2 is a diagrammatic illustration of a top view of the embodiment of the cell shown in FIG. 1.

FIG. 3A is a diagrammatic top view of the folded cell shown in FIG. 1.

FIG. 3B is a perspective view of the folded cell shown in FIG. 1.

FIG. 4 is a diagrammatic illustration of an alternative embodiment of a cell having one cathode and multiple anodes.

FIG. 5 is a diagrammatic illustration of a top view of the embodiment of the cell shown in FIG. 4.

FIG. 6A is a diagrammatic top view of the folded cell shown in FIG. 4.

FIG. 6B is a perspective view of the folded cell shown in FIG. 4.

FIG. 7 is a diagrammatic illustration of a front view of one embodiment of a cell having one cathode and multiple anodes.

FIG. 8 is a diagrammatic illustration of a top view of the embodiment of the cell shown in FIG. 7.

FIG. 9A is a diagrammatic top view of the folded cell shown in FIG. 7.

FIG. 9B is a perspective view of the folded cell shown in FIG. 7.

FIG. 10 is a diagrammatic illustration of a front view of an alternative embodiment of a cell having one anode and multiple cathodes.

FIG. 11 is a diagrammatic illustration of a top view of the embodiment of the cell shown in FIG. 10.

FIG. 12A is a diagrammatic top view of the folded cell shown in FIG. 10.

FIG. 12B is a perspective view of the folded cell shown in FIG. 10.

FIG. 13 is a diagrammatic illustration of a front view of one embodiment of a cell with an outside current collector and having one anode and multiple cathodes.

FIG. 14 is a diagrammatic illustration of a top view of the embodiment of the cell shown in FIG. 13.

FIG. 15A is a diagrammatic top view of the folded cell shown in FIG. 13.

FIG. 15B is a perspective view of the folded cell shown in FIG. 13.

FIG. 16 is a diagrammatic illustration of a front view of an alternative embodiment of a cell with an outside current collector and having one cathode and multiple anodes.

FIG. 17 is a diagrammatic illustration of a top view of the embodiment of the cell shown in FIG. 16.

FIG. 18A is a diagrammatic top view of the folded cell shown in FIG. 16.

FIG. 18B is a perspective view of the folded cell shown in FIG. 16.

FIG. 19 is a diagrammatic illustration of a front view of one embodiment of a cell with an outside current collector and having one cathode and multiple anodes.

FIG. 20 is a diagrammatic illustration of a top view of the embodiment of the cell shown in FIG. 19.

FIG. 21A is a diagrammatic top view of the folded cell shown in FIG. 19.

FIG. 21B is a perspective view of the folded cell shown in FIG. 19.

FIG. 22 is a diagrammatic illustration of a front view of one embodiment of a cell with an outside current collector and having one anode and multiple cathodes.

FIG. 23 is a diagrammatic illustration of an alternative embodiment of the cell shown in FIG. 22.

FIG. 24A is a diagrammatic top view of the folded cell shown in FIG. 22.

FIG. 24B is a perspective view of the folded cell shown in FIG. 22.

### DETAILED DESCRIPTION

An electrode cell has two opposite electrodes, an anode (negative electrode) and cathode (positive electrode), with a separator between them. Each electrode (the anode and/or the cathode) may be comprised of two or more layers that are separated by a current collector. For example, an anode may be comprised of two negative electrode layers separated by a negative current collector, and/or the cathode may be comprised of two positive electrode layers separated by a positive current collector. The plane of the current collector is generally parallel to the plane of the polymer matrix film portion of the electrode. Similarly, the plane of separator films is generally parallel to the plane of the electrodes.

The electrodes and separator are adhered to form a cell. As known to one skilled in the art, adherence may be by laminating using pressure (manual and/or mechanical), heat, or a combination of pressure and heat. When the components are adhered or laminated, there is a series of generally planar laminated elements. The number of layers may make cell configurations difficult, particularly in relation to achieving a desired configuration. As used herein, cell configurations refer to the result of physical manipulations of the adhered layers that are performed to achieve a compact functional cell, and include folding, rolling, shaping, etc. The battery may be shaped into folds of parallel and alternating ridges and grooves, with a resulting corrugated structure. Positive and negative terminals, also referred to as tabs, are used to establish or break the electrical connection of the cell.

Various designs are contemplated to configure a cell in which one electrode is continuous, while the other electrode is discontinuous. More specifically, the electrode that will be the outermost electrode of the final cell, either the anode or the cathode, is configured as continuous. The opposite electrode is configured as discontinuous. For example, a cell designed with a discontinuous inner negative electrode will have a continuous outer positive electrode, and a cell designed with a discontinuous inner positive electrode will have a continuous outer negative electrode. As used herein, discontinuous is defined as an anode or cathode in which the charge of that electrode, either positive or negative, is carried by a plurality of joined electrodes or multiple joined electrodes, rather than by a single electrode. Thus, as used herein, multiple electrodes refer to discontinuous electrodes or components, and a single electrode refers to a continuous electrode.

The number of discontinuous electrodes or components, making up the inner electrode, depends upon the parameters desired in the resulting cell (e.g., size, power, efficiency), as determined by one skilled in the art. The inventive cell configurations, and methods for producing these cell configurations, allow for increased flexibility in battery design. The cell configurations can be used to produce a battery of any size or capacity, for example, a multibicell battery, a multicell battery, a battery having multiple modules that each have multiple multicells or multibicells, etc.

The inventive cell configurations, and method for preparing the cell configurations, provide several desirable features. They allow uniformity in the structure and performance of multicell batteries. The batteries thus configured have continuous adherence of the middle as well as the external or final cell electrodes (both multicell and multibicell). This advantageously results in improved cell capacity, life cycle, and power. The normal loss of the first charge/discharge cycle of the cell is also reduced or eliminated, because the inventive design improves uniformity of battery charge and discharge. Impedence of every individual cell or bicell is equal, with the same voltage and same capacity.

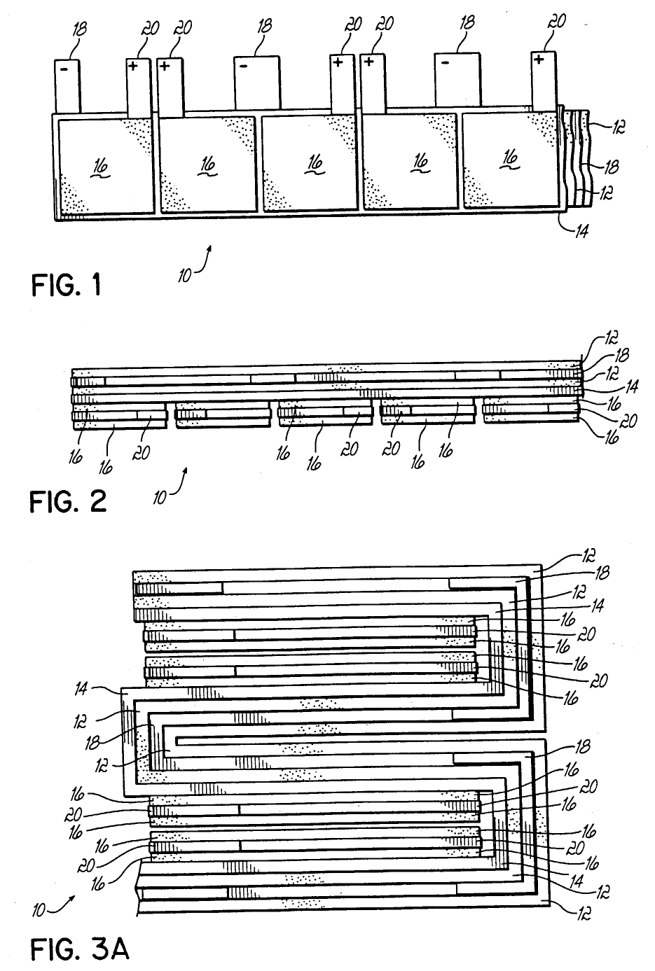

One embodiment of the invention, shown in FIGS. 1, 2, 3A and 3B, is a multicell 10 design having a single anode 12 (negative electrode) configured as the exterior of the folded cell 10, a separator 14, and multiple cathodes 16 (positive electrodes) configured in the interior or inner surface of the cell 10. That is, a separator 14 separates a single anode 12 from multiple cathodes 16. FIG. 1 shows a front view, and FIG. 2 shows a top view of such a multicell 10. While FIG. 1 illustrates a multicell having five components of the cathode (five unicells), multicells with two, three, or four components of the cathode may be used, as well as multicells with greater than five components of the cathode, as previously described. Negative current collectors 18 are positioned in the anode 12 thereby splitting the anode 12 into two layers, as shown, and positive current collectors 20 are positioned in each of the multiple cathodes 16 thereby splitting each cathode 16 into two layers, as shown.

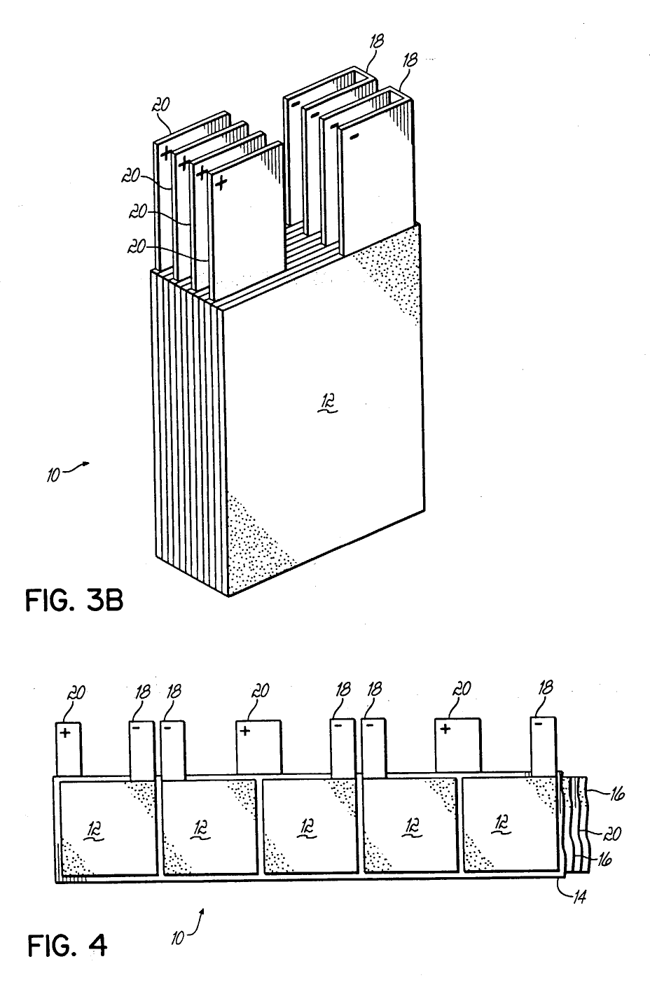

The multicell depicted in FIGS. 1 and 2 may alternatively be in a zig-zag or folded configuration, with FIG. 3A showing a top view and FIG. 3B showing a perspective view. In this embodiment, there is a single anode 12 with a negative current collector 18 located throughout the entire geometry, thereby splitting the anode 12 into two layers, as shown. The multiple cathodes 16 are configured so that the parallel surfaces of the separator layer 14 separate the continuously configured anode 12 from two discontinuously configured cathodes 16. The multiple cathodes 16, being discontinuous, thus do not assume the zig-zag configuration. Positive current collectors 20 are located in each of the multiple cathodes 16, thereby splitting each cathode 16 into two layers, as shown.

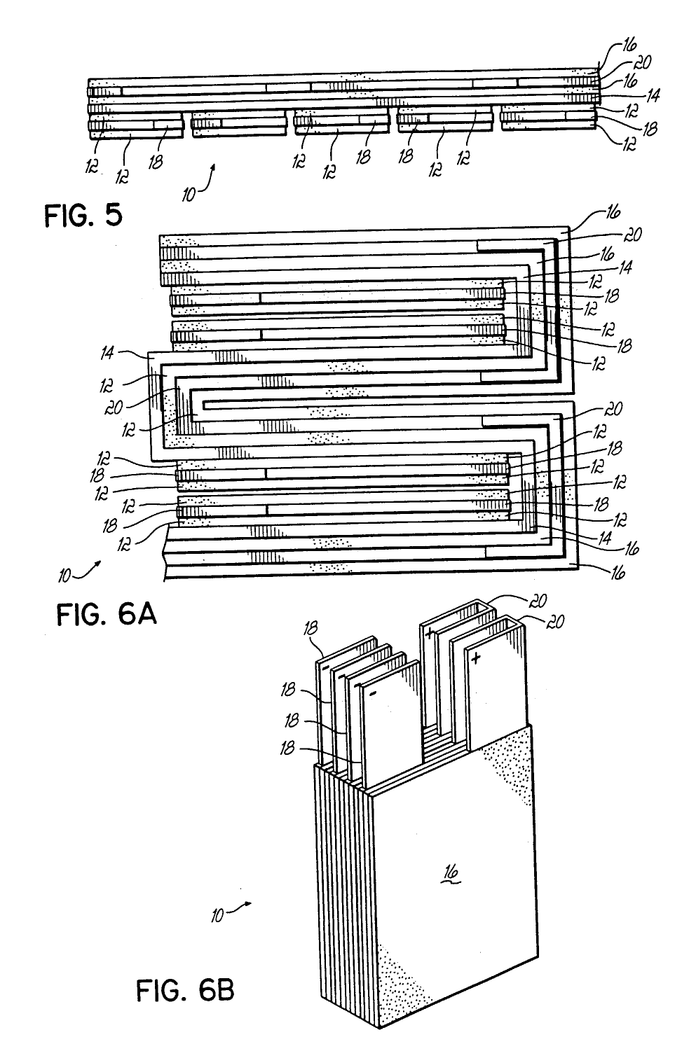

An alternative embodiment of the invention, shown in FIGS. 4, 5, 6A and 6B, is a multicell 10 design having a single cathode 16 (positive electrode) configured as the exterior of the folded cell 10, a separator 14, and multiple anodes 12 (negative electrodes) configured in the interior or inner surface of the cell 10. That is, a separator 14 separates a single cathode 16 from multiple anodes 12. FIG. 4 shows a front view, and FIG. 5 shows a top view of such a cell 10. Positive current collectors 20 are positioned in the cathode 16 thereby splitting the cathode 16 into two layers, as shown, and negative current collectors 18 are positioned in each of the multiple anodes 12 thereby splitting each anode 12 into two layers, as shown.

The multicell depicted in FIGS. 4 and 5 may alternatively be in a zig-zag or folded configuration, with FIG. 6A showing a top view and FIG. 6B showing a perspective view. In this embodiment, there is a single cathode 16 with a positive current collector 20 located throughout the entire geometry, thereby splitting the cathode 16 into two layers. The multiple anodes 12 are configured so that the parallel surfaces of the separator layer 14 separate the continuously configured cathode 15 from two discontinuously configured anodes 12. The multiple anodes 12, being discontinuous, thus do not assume the zig-zag configuration. Negative current collectors 18 are located in each of the multiple anodes 12, thereby splitting each anode 12 into two layers.

Another embodiment of the invention is a multibicell where the electrode forming the outermost layer of the final cell is configured discontinuously. In a bicell, components are adhered so that a pair of electrodes having the same charge sandwich one electrode having the opposite charge. Any or all of the electrodes may be comprised of a plurality of layers. For example, each anode in the pair of anodes (negative electrodes) may have a negative current collector therebetween, thereby splitting each anode of each pair into two layers. The cathode may have a positive current collector positioned therein, thereby splitting the cathode into two layers. One of the anode pair is located above, and the other of the anode pair is located below, the cathode. The anodes are in a discontinuous configuration. Each anode is separated from the cathode by a separator.

All components (i.e., the two pairs of anode layers sandwiching the cathode layers, current collectors, and separator adhered to form a bicell, and the plurality of bicells) are joined or adhered to form a multibicell. As previously described, adherence may be by laminating using pressure (manual and/or mechanical), heat, or a combination of pressure and heat. Advantageously, a single adherence process, controlled by a single thermal management system, can be used as known to one skilled in the art, for example, for charge voltage and discharge voltage.

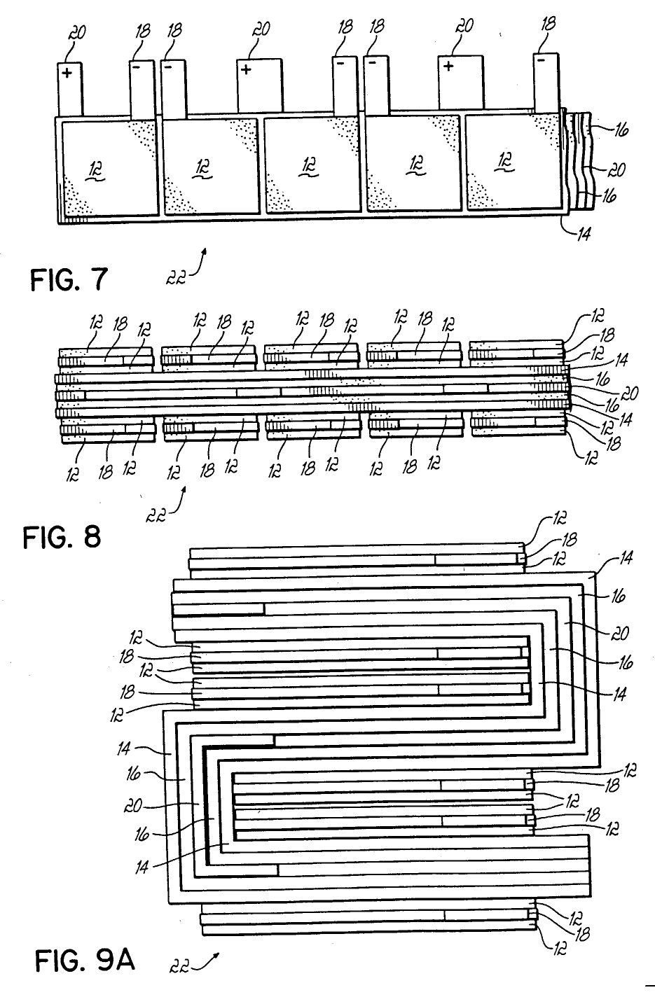

FIGS. 7, 8, 9A and 9B are multibicell 22 designs having a single cathode 16 (positive electrode) configured in the interior of the folded cell 10, a pair of separators 14, and a pair of discontinuous anodes 12 (negative electrodes) as the outermost electrodes. That is, one separator 14 separates a single cathode 16 on one side from two anodes 12, and another separator 14 separates the single cathode 16 on the other side from two anodes 12. FIG. 7 shows a front view, and FIG. 8 shows a top view of such a multibicell 22. While FIG. 7 illustrates a multibicell 22 having five components of the anode 12 (five bicells), multibicells with two, three, or four components of the anode may be used, as well as multibicells with greater than five components of the anode, as previously described.

A single positive current collector 20 is positioned in the cathode 16, thereby splitting the cathode 16 into a pair of cathode layers 16. A plurality of negative current collectors 18 are positioned in each of the multiple anodes 12, thereby splitting each of the multiple anodes 12 into a pair of anode layers 12.

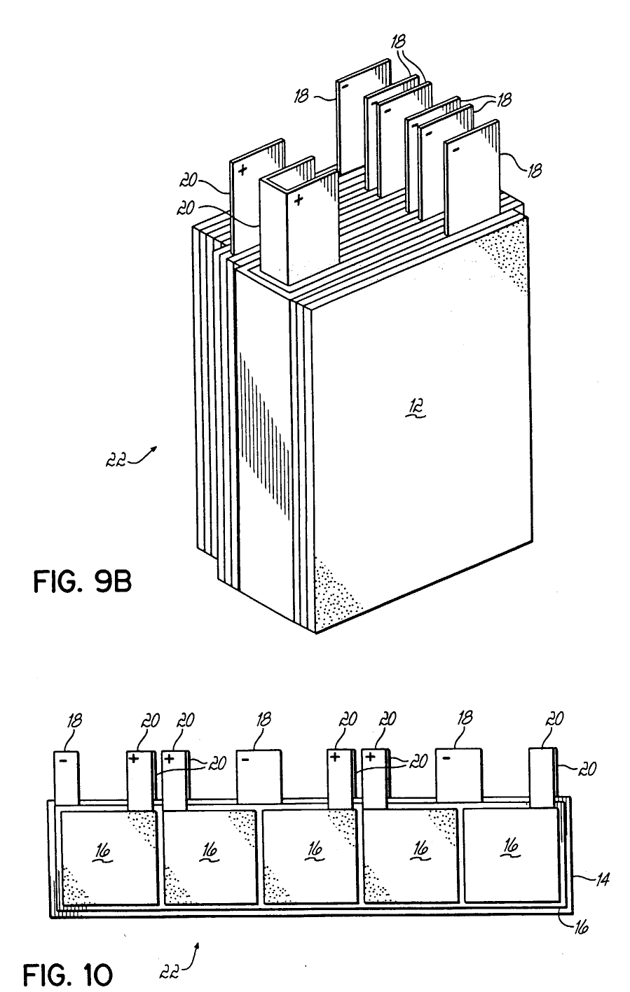

The multibicell 22 depicted in FIGS. 7 and 8 may be in a zig-zag or folded configuration, with FIG. 9A showing a top view and FIG. 9B showing a perspective view. In this embodiment, there is a single cathode 16 with a positive current collector 20 located throughout the entire geometry, thereby splitting the cathodes 16 into two cathode layers 16. The multiple anodes 12 are configured so that each of the parallel surfaces of the separator layer 14 separate the continuously configured cathode 16 from two discontinuously configured anodes 12. The multiple anodes 12, being discontinuous, thus do not assume the zig-zag configuration. Negative current collectors 18 are located in each of the multiple anodes 12, thereby splitting each of the multiple anodes 12 into two anode layers 12, and positive current collectors 20 are located throughout the geometry of the cathodes 16, thereby splitting the cathodes 16 into two cathode layers 16.

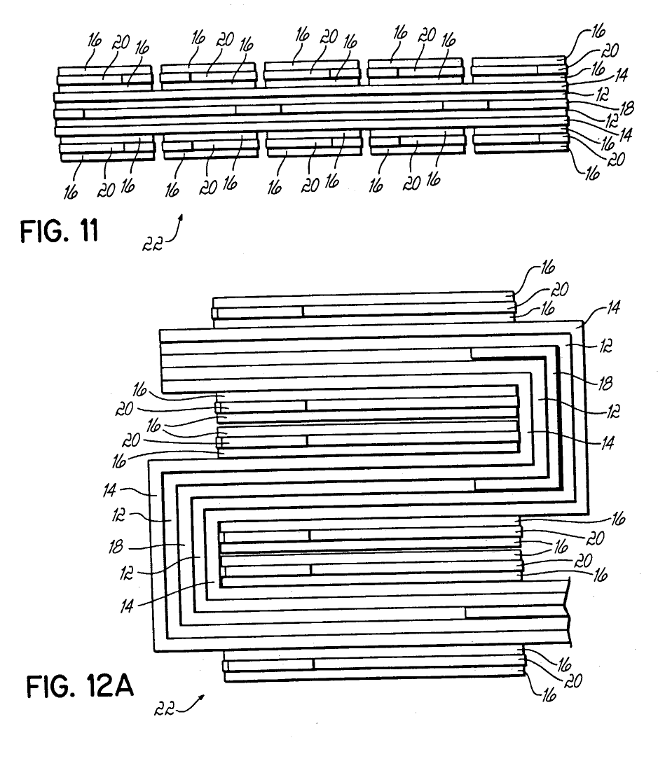

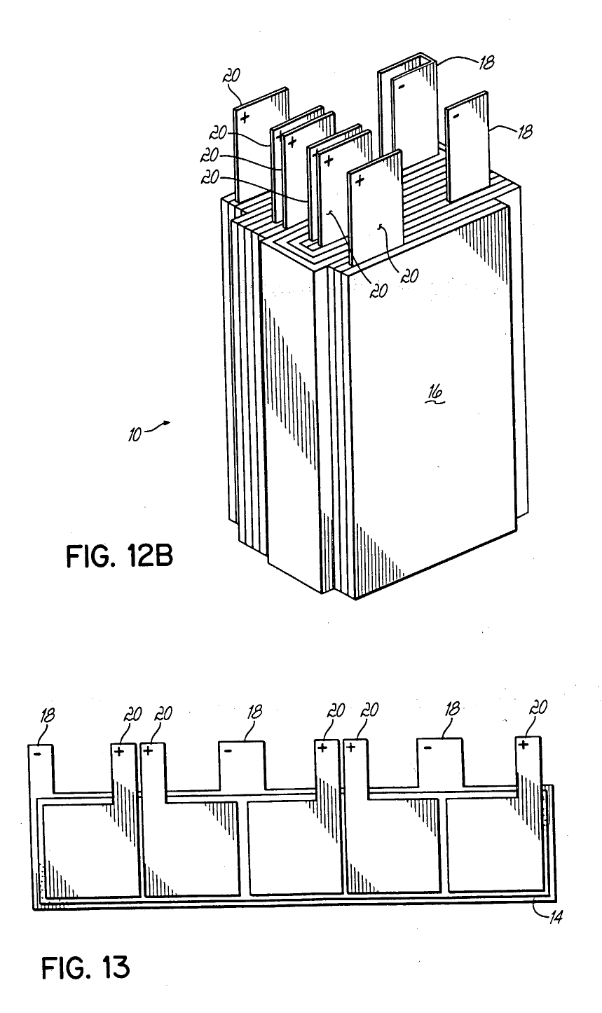

FIGS. 10, 11, 12A and 12B show bicell 22 configurations which parallel those shown in FIGS. 7, 8, 9A and 9B, respectively, except for the identity of the electrode. FIGS. 10 and 11, in front view and top view, respectively, show two discontinuous cathodes 16 (as pairs of two cathode layers 16) sandwiching a single continuous anode 12 (as two anode layers 12). FIGS. 12A and 12B show the multibicell 22 in a zig-zag or folded configuration. FIG. 12A shows a top view, and FIG. 12B shows a perspective view.

Any of the above-described cells may include embodiments in which a current collector is on the outermost surface of an electrode. In these embodiments, the current collector does not split the electrode into two layers. For example, an anode may be separated from a cathode by a separator layer, with the negative current collector on the exterior surface of the anode, and/or the positive current collector on the exterior surface of the cathode. Discontinuous and continuous electrode configurations of this embodiment are shown in the following figures.

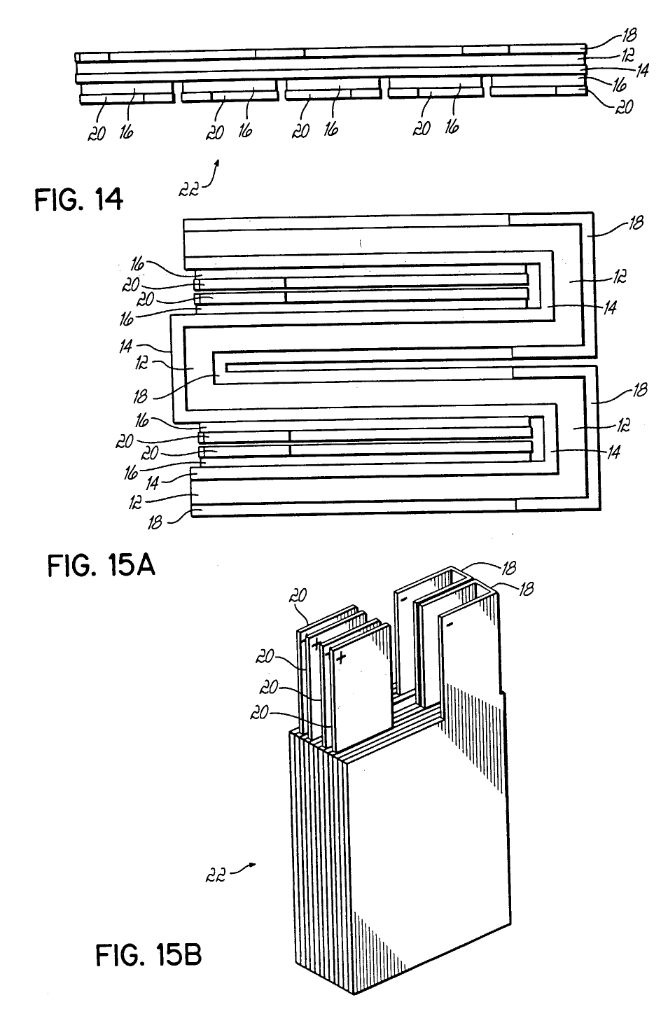

FIGS. 13, 14, 15A and 15B are multicell designs having current collectors external to a single anode 12 (negative electrode) configured as the outermost electrode in a folded cell 10, a separator 14, and multiple cathodes 16 (positive electrodes) configured as inner electrodes in a folded cell 10. That is, a separator 14 separates a single anode 12 from multiple cathodes 16. FIG. 13 shows a front view, and FIG. 14 shows a top view of such a cell 10. A single negative current collector 18 is positioned external to the anode 12 throughout the entire geometry. A plurality of positive current collectors 20 are positioned external to each of the multiple cathodes 16 throughout the entire geometry.

The cell 10 depicted in FIGS. 13 and 14 may be in a zig-zag or folded configuration, with FIG. 15A showing a top view and FIG. 15B showing a perspective view. In this embodiment, there is a single anode 12 with a negative current collector 18 located external to the anode 12 throughout the entire geometry. The multiple cathodes 16 are configured so that the facing parallel surfaces of the separator layers 14 separate the continuously configured anode 12 from two discontinuously configured cathodes 16, and the two discontinuously configured cathodes 16 with external current collectors 20 are mirror images. The multiple cathodes 16, being discontinuous, thus do not assume the zig-zag configuration.

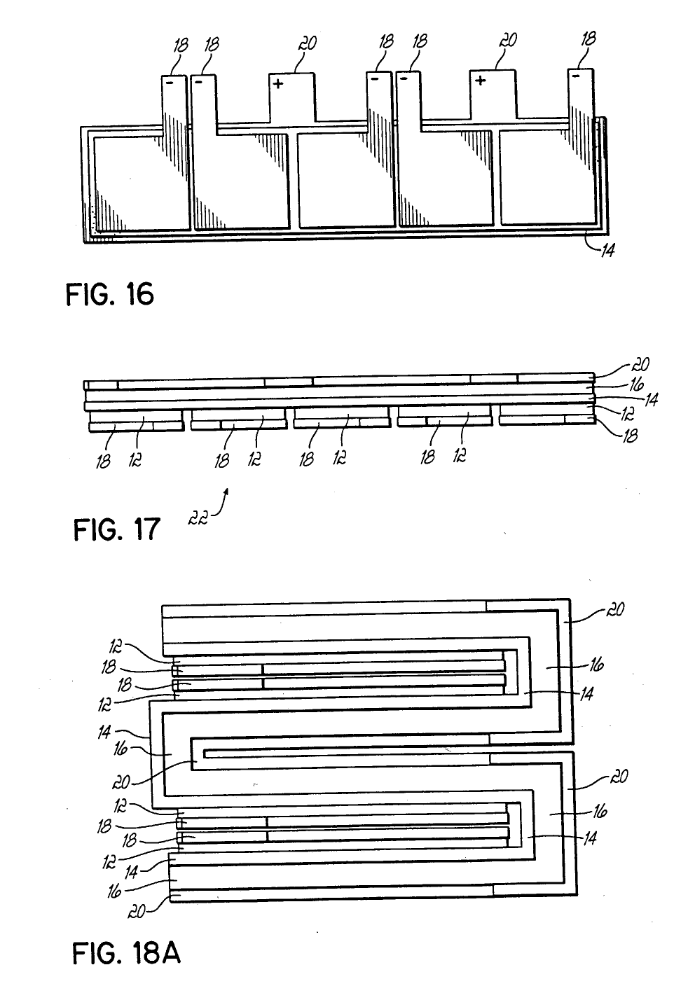

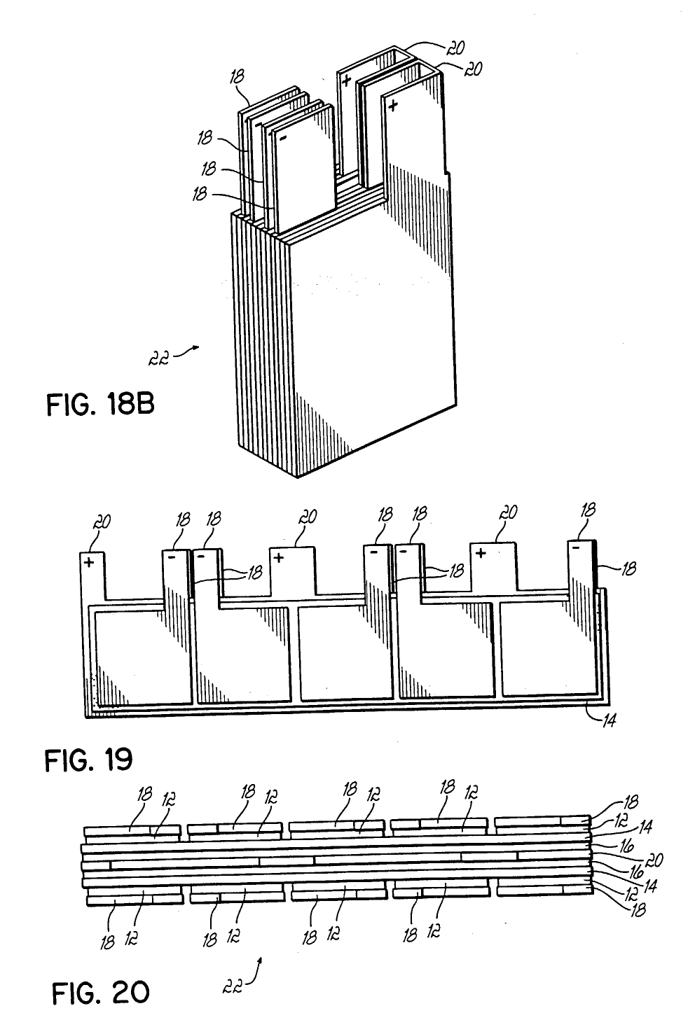

FIGS. 16, 17, 18A and 18B show multicells having external current collectors which parallel those shown in FIGS. 13, 14, 15A and 15B, respectively, except for the charge of the electrode. FIG. 16 shows a front view, and FIG. 17 shows a top view, of a positive current collector 20 located external to a single cathode 16 (positive electrode), a separator 14, and multiple anodes 12 (negative electrodes) with a negative current collector 18 located external to each of the multiple anodes 12. The multiple anodes 12 are configured so that the facing parallel surfaces of the separator layers 14 separate the continuously configured cathode 16 from two discontinuously configured anodes 12, and the two discontinuously configured anodes 12 with external current collectors 18 are mirror images. The multiple anodes 16, being discontinuous, thus do not assume the zig-zag configuration. FIGS. 18A and 18B show a folded or zig-zag configuration, with FIG. 18A showing a top view, and FIG. 18B showing a perspective view. As shown in FIGS. 18A and 18B, the positive current collector 20 is located external to the cathode 16 throughout the entire geometry.

FIGS. 19, 20, 21A and 21B are multibicell 22 designs. A single cathode 16 (positive electrode) is configured in the interior of the folded cell 10, and the cathode 16 is split into two cathode layers 16 by a positive current collector 20. A pair of separators 14 separates each of the cathode layers 16 from a pair of discontinuous anodes 12 (negative electrodes). That is, one separator 14 separates one cathode layer 16 on one side from two anodes 12, and another separator 14 separates the other cathode layer 16 on the other side from two anodes 12. Each anode 12 has an external current collector 18.

FIG. 19 shows a front view, and FIG. 20 shows a top view of such a multibicell 22. While FIG. 19 illustrates a multibicell 22 having five components of the anode 12 (five bicells), multibicells with two, three, or four components of the anode 12 may be used, as well as multibicells with greater than five components of the anode 12, as previously described.

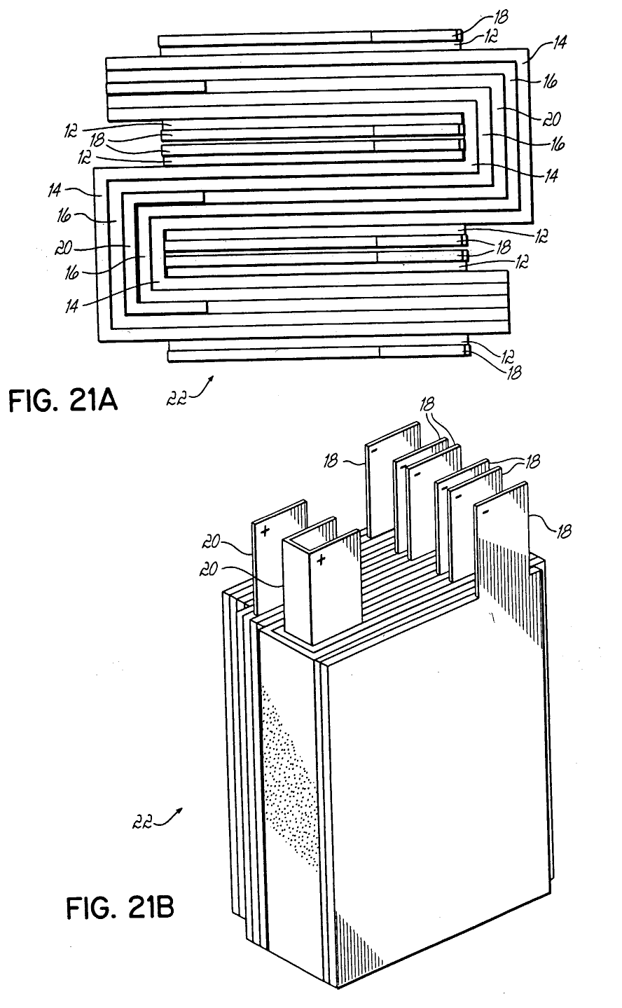

The multibicell 22 depicted in FIGS. 19 and 20 may be in a zig-zag or folded configuration, with FIG. 21A showing a top view and FIG. 21B showing a perspective view. In this embodiment, there is a single cathode 16 with a positive current collector 20 located internal to the cathode 16 throughout the entire geometry, thereby splitting the cathode 16 into two cathode layers 16. The multiple anodes 12 are configured so that each of the parallel surfaces of the separator layer 14 separate the continuously configured cathode layers 16 from two discontinuously configured anodes 12. The anodes 12, being discontinuous, thus do not assume the zig-zag configuration. Negative current collectors 18 are located external to each of the anodes 12, and form the outermost surface of the folded cell, as shown in FIG. 21B. The multiple anodes 12 are configured so that each of the parallel surfaces of the separator layer 14 separate the continuously configured cathode 16 from two discontinuously configured anodes 12. The multiple anodes 12, being discontinuous, thus do not assume the zig-zag configuration.

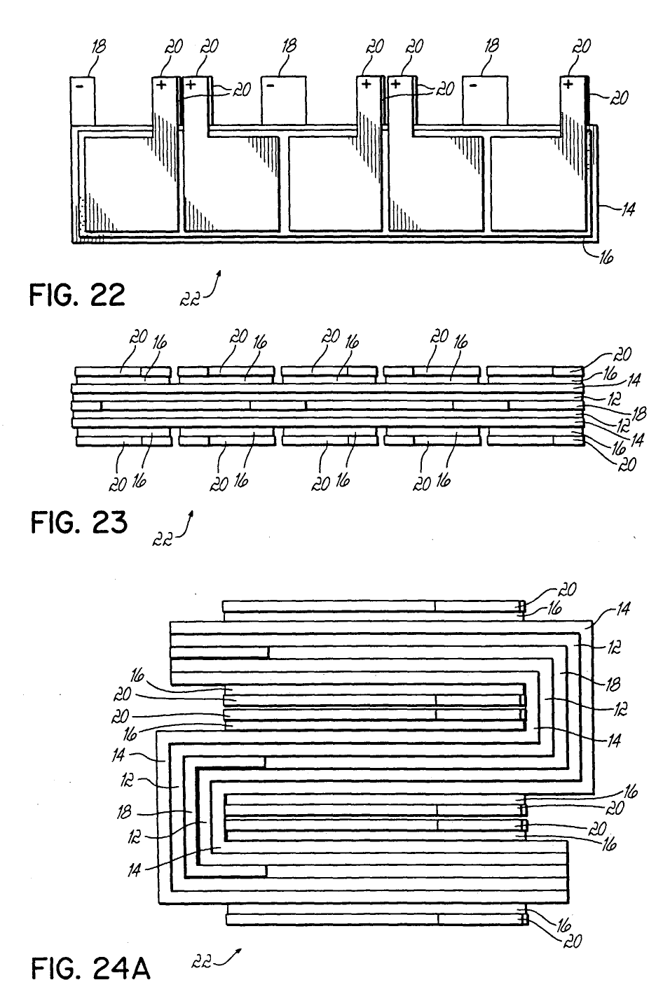

FIGS. 22, 23, 24A and 24B show multibicell 22 configurations which parallel those shown in FIGS. 19, 20, 21A and 21B, respectively, except for the charge of the electrode. A single anode 12 (negative electrode) is configured in the interior of the folded cell 10, and the anode 12 is split into two anode layers 12 by a negative current collector 18. A pair of separators 14 separates each of the anode layers 12 from a pair of discontinuous cathodes 16 (positive electrodes). That is, one separator 14 separates one anode layer 12 on one side from two cathodes 16, and another separator 14 separates the other anode layer 12 on the other side from two cathodes 16. Each cathode 16 has an external current collector 20.

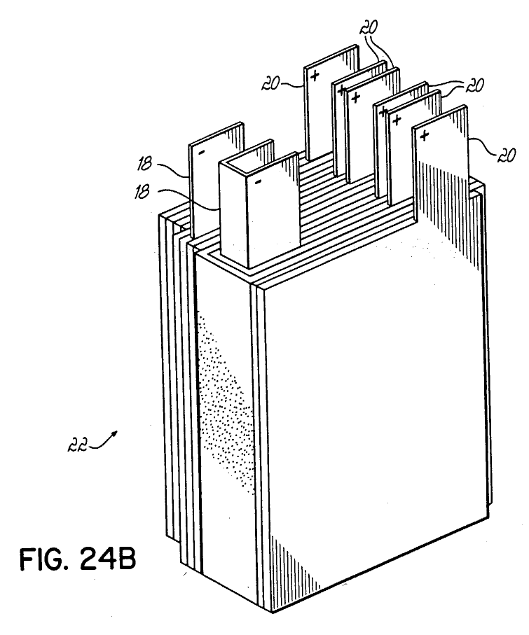

The multibicell 22 depicted in FIGS. 22 and 23 may be in a zig-zag or folded configuration, with FIG. 24A showing a top view and FIG. 24B showing a perspective view. In this embodiment, there is a single anode 12 with a negative current collector 18 located internal to the anode 12 throughout the entire geometry, thereby splitting the anode 12 into two anode layers 12. The multiple cathodes 16 are configured so that each of the parallel surfaces of the separator layer 14 separate the continuously configured anode layers 12 from two discontinuously configured cathodes 16. The cathodes 16, being discontinuous, thus do not assume the zig-zag configuration. Positive current collectors 20 are located external to each of the cathodes 16, and form the outermost surface of the folded cell, as shown in FIG. 24B.

With a cell having at least one continuous electrode and two discontinuous electrodes, where either the anode is the continuous electrode and the cathodes are the discontinuous electrodes, or the cathode is the continuous electrode and the anodes are the discontinuous electrodes, any of the following embodiments of a cell are possible: the cell may be a multicell (FIGS. 1-6; FIGS. 13-18) or a multibicell (FIGS. 7-12; FIGS. 19-24). In either the multicell or multibicell embodiments, the cell may have one anode and one cathode with a current collector between the anode and the cathode, or the cell may have two anodes separated by a negative current collector between the anodes, thereby splitting the anode into two anode layers, and/or the cell may have two cathodes separated by a positive current collector between the cathodes, thereby splitting the cathode into two cathode layers. In a multibicell embodiment, both negative and positive current collectors may be on the outer surface of the respective anode and cathode (FIGS. 13, 14, and 15). In a multibicell embodiment, negative current collectors may be on the outer surface of the anodes and positive current collectors may be between a single cathode, thus splitting the cathode into two layers the two cathodes (FIGS. 19, 20, and 21), or positive current collectors may be on the outer surface of the cathodes, and negative current collectors may be between a single anode, thus splitting the anode into two anode layers (FIGS. 22, 23, and 24).

While the present invention has been illustrated by the description of an embodiment thereof, and while the embodiment has been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and method and illustrative examples shown and described. Accordingly, departures may be made from such details without departing from the scope or spirit of Applicant=s general inventive concept.

What is claimed is:

1. A lithium polymer battery comprising at least one cell, said cell comprising a first electrode configured continuously, at least one second electrode of opposite charge from the first electrode configured discontinuously, and a separator between the first and second electrodes.

2. The battery of claim 1 wherein the cell is selected from the group consisting of a multicell and a multibicell.

3. The battery of claim 1 wherein the cell has a configuration selected from the group consisting of
at least one anode and at least one cathode,
at least one anode having a current collector positioned therein and at least one cathode,
at least one cathode having a current collector positioned therein and at least one anode, and
at least two anode and at least two cathodes, said anode and cathodes each having a current collector positioned therein.

4. The battery of claim 3 wherein said at least one anode has an external current collector.

5. The battery of claim 3 wherein said at least one cathode has an external current collector.

6. The battery of claim 1 wherein the cell is a multibicell comprising an outer pair of two anode layers with a negative current collector between the anode layers and an inner pair of two anode layers with a negative current collector between the anode layers, and a cathode comprising two cathode layers with a positive current collector between the cathode layers, said cathode between said outer pair of anode and said inner pair of anodes, said multibicell further comprising a separator between said outer pair of anodes and said inner pair of anodes and said cathode.

7. The battery of claim 1 wherein the cell is a multibicell comprising an outer pair of two cathode layers with a positive current collector between the cathode layers and an inner pair of two cathode layers with a positive current collector between the cathode layers, and an anode comprising two anode layers with a negative current collector between the anode layers, said anode between said outside pair of cathodes and said inner pair of cathodes, said multibicell further comprising a separator between said outer pair of cathodes and said inner pair of cathodes and said anode.

8. The battery of claim 1 further comprising a current collector for at least one of the electrodes.

9. The battery of claim 8 wherein the current collector is aluminum foil, grid, or mesh for a positive electrode, and copper foil, grid, or mesh for a negative electrode.

10. The battery of claim 8 wherein the current collector is on an outer surface of at least one electrode.

11. The battery of claim 8 wherein the current collector is on an inner surface of at least one electrode.

12. The battery of claim 8 wherein the current collector is positioned in at least one electrode to split the electrode into at least two layers.

13. A lithium polymer battery comprising at least one cell, said cell comprising a first electrode, at least one second electrode of opposite charge from the first electrode, and a separator between the first and second electrodes, the battery in a corrugated configuration with the first electrode continuous and the second electrode discontinuous.

14. The battery of claim 13 wherein the cell is selected from the group consisting of a multicell and a multibicell.

15. The battery of claim 13 wherein the cell is selected from the group consisting of
at least one anode and at least one cathode,
at least one anode having a current collector positioned therein and at least one cathode,
at least one cathode having a current collector positioned therein and at least one anode, and
at least two anodes and at least two cathodes, said anodes and cathodes each having a current collector positioned therein.

16. The battery of claim 13 wherein the cell is a multibicell comprising an outer pair of two anode layers with a negative current collector between the anode layers and an inner pair of two anode layers with a negative current collector between the anode layers, and a cathode comprising two cathode layers with a positive current collector between the cathode layers, said cathode between said outer pair of anodes and said inner pair of anodes, said multibicell further comprising a separator between said outer pair of anodes and said inner pair of anodes and said cathode.

17. The battery of claim 13 wherein the cell is a bicell comprising an outer pair of two cathode layers with a positive current collector between the cathode layers and an inner pair of cathode layers with a positive current collector between the cathode layers, and an anode comprising two anode layers with a negative current collector between the anode layers, said anode between said outer pair of cathodes and said inner pair of cathodes, said multibicell further comprising a separator between said outer pair of cathodes and said inner pair of cathodes and said anode.

18. The battery of claim 13 further comprising a current collector for at least one of the electrodes.

19. The battery of claim 18 wherein the current collector is aluminum foil, grid, or mesh for a positive electrode, and copper foil, grid, or mesh for a negative electrode.

20. The battery of claim 18 wherein the current collector is on an outer surface of the electrode and is configured continuously.

21. The battery of claim 18 wherein the current collector is on an inner surface of the electrode and is configured discontinuously.

22. A method for preparing a lithium polymer cell comprising
(a) providing a continuous electrode, at least two discontinuous electrodes, and a separator between said continuous electrode and said discontinuous electrodes, and
(b) adhering the separator to the continuous and discontinuous electrodes to form a multicell.

23. The method of claim 22 further comprising
(c) configuring the multicell with the discontinuous electrodes in the interior of the multicell and the continuous electrode at the exterior of the multicell.

24. The method of claim 22 further comprising repeating steps (a) and (b) to form a plurality of multicells and adhering the plurality of cells to form a battery.

25. The method of claim 24 further comprising
(c) configuring the battery with the discontinuous electrodes in the interior of the battery and the continuous electrode at the exterior of the battery.

26. The method of claim 22 wherein adhering the plurality of cells is by a single process.

27. The method of claim 26 wherein the adhering process is controlled by a thermal management system.

28. The method of claim 23 wherein configuring is by a method selected from the group consisting of rolling, folding, bending, and combinations thereof.

29. The method of claim 25 wherein configuring is by a method selected from the group consisting of rolling folding, bending, and combinations thereof.
